(19) United States
(12) Patent Application Publication
(10) Pub. No.: US 2019/0065464 A1
(43) Pub. Date: Feb. 28, 2019

(54) ARTIFICIAL INTELLIGENCE SCRIBE

(71) Applicant: EMR.AI Inc., San Francisco, CA (US)

(72) Inventors: Greg P. Finley, St. Paul, MN (US); Erik Edwards, Oakland, CA (US); Amanda Robinson, San Leandro, CA (US); Najmeh Sadoughi, Pittsburgh, PA (US); James Fone, Twyford (GB); Mark Miller, London (GB); David Suendermann-Oeft, San Francisco, CA (US); Wael Salloum, San Leandro, CA (US)

(21) Appl. No.: 15/916,237

(22) Filed: Mar. 8, 2018

Related U.S. Application Data
(60) Provisional application No. 62/553,071, filed on Aug. 31, 2017.

(51) Int. Cl. G06F 17/27; G06N 3/08; G06F 17/24

(52) U.S. Cl. CPC G06F 17/2785; G06F 17/241; G06N 3/08

(57) ABSTRACT

Systems, methods, and computer-readable non-transitory storage medium for communicating medical information based at least in part on an oral communication between a doctor and a patient is disclosed. In this method and system, doctor and patient's respective contexts is inferred from the oral communication. It is also preferred that diagnostic information and respective contexts of the communications can be also inferred. Then, a desired impact of a recipient to a written communication related to the oral communication is inferred. Once the desired impact is inferred, the system generates output text using an artificial intelligence system, or by accessing a database of a plurality of stock phrases, to have appropriate surface text, and subtext, and optionally appropriate tone. The output text can be selected as a function of inferred diagnostic information, the inferred doctor and recipient's respective contexts, the desired impact, and the stock phrases.

### CROSS-REFERENCE TO RELATED APPLICATION

This application claims priority under 35 U.S.C. 119(e) from U.S. Provisional Patent Application Ser. No. 62/553,071, titled “Artificial Intelligence Scribe”, filed on Aug. 31, 2017.

### FIELD OF INVENTION

The field of the invention is communication of medical information using an automated system.

### BACKGROUND

The following description includes information that can be useful in understanding the present disclosure. It is not an admission that any of the information provided herein is prior art or relevant to the presently claimed invention, or that any publication specifically or implicitly referenced is prior art.

Variations of Artificial Intelligence (“AI”) have been used in many different fields, including science, gaming industry, statistics, etc. For example, Google's AlphaGo™ is an AI game that mimics human play, and then improves its own play by running large numbers of games against other instances of itself.

AI has also been used to automatically detect human emotional states, using prosody of speech. For example, U.S. Pat. Pub. No. 20060122834 A1 to Bennett discloses a prosody and emotion recognition system that enables a quick and accurate recognition of speech utterance based on literal content and user emotional state information. For another example, U.S. Pat. No. 8,682,666 to Degani discloses method and system to determine current behavioral, psychological and speech styles characteristics of a speaker in a given situation and context by analyzing the speech utterances of the speaker.

AI has also been put to use in automatically and contextually summarizing human communications. For example, U.S. Pat. No. 9,420,227 to Shires discloses a system for differentiating between two or more individuals' voice data during a conversation, and the producing corresponding text for each individual. Shires also discloses AI use of voice data, physical features of the speakers, characteristics of the words utilized, etc. to generate summarized output.

Still further, AI has been used to detect errors in medical communications. For example, U.S. Pat. Pub. No. 2014/0012575 to Ganong discloses a system that can detect speech input in a medical or other field, and evaluate the speech for indications of potential significant errors.

Despite all the work in AI over the years, there doesn't appear to be any work directed to creating de novo communications that have appropriate tone, surface text, and subtext, as might be particularly useful in communicating medical information to different recipients.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF INVENTION

The subject matter described herein provides computer enabled apparatus, systems and methods for automatically generating custom communications to recipients. A particular focus is for the generated communications to take into account how different recipients can be expected to respond to the communications, on both intellectual and emotional levels.

Contemplated methods include deciphering what each person is saying during a conversation, making multiple inferences from the words, prosody, and possibly other observable cues of the conversation, and then generating written or other communications summarizing the conversation. In some embodiments, stock phrases are selected and assembled with a goal of achieving surface text, subtext and tone.

In a doctor-patient interaction, for example, the computer generated communication(s) might include guidance based upon inferred diagnostic information, inferred doctor and recipient's respective contexts, and desired impacts on the recipients of the communication(s). Thus, systems and methods contemplated herein would very likely generate different communications for patients, family members, and consulting physicians. Also, systems and methods contemplated herein would very likely generate different communications to patients having similar diagnoses, but different prognoses. Such differences can advantageously result from different tones, surface texts, and subtexts in the communications.

The various inferences can be obtained from suitable AI systems, by submitting text and/or audio through established APIs. Some or all of the contemplated inferencing and other steps can be performed in real time or near real time. Various objects, features, aspects and advantages of the disclosed subject matter will become more apparent from the following detailed description of embodiments, along with the accompanying drawing figures in which like numerals represent like components.

### BRIEF DESCRIPTION OF THE DRAWING

FIG. 1a is a schematic of an automatic response generation system.

FIG. 1b is a diagram representing the steps of generating a response by tagging concepts and relations, mapping and natural language generation.

FIG. 2 is a diagram illustrating the process of training a tagging module with sample data to predict appropriate emotional context or tone.

FIG. 3 is an overview of the stages of an automated medical scribe for documenting clinical encounters.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc) configured to execute software instructions stored on a computer readable tangible, non-transitory medium (e.g., hard drive, solid state drive, RAM, flash, ROM, etc). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network. The terms “configured to” and “programmed to” in the context of a processor refer to being programmed by a set of software instructions to perform a function or set of functions.

While the inventive subject matter is susceptible of various modification and alternative embodiments, certain illustrated embodiments thereof are shown in the drawings and will be described below in detail. It should be understood, however, that there is no intention to limit the invention to the specific form disclosed, but on the contrary, the invention is to cover all modifications, alternative embodiments, and equivalents falling within the scope of the claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities or ranges, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention can contain certain errors necessarily resulting from the standard deviation found in their respective testing measurements. Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified, thus fulfilling the written description of all Markush groups used in the appended claims.

### Exemplary Embodiments of a Deep-Learning-Based Auto-Scribe

The following method/system is able to transform recordings of spoken interactions between a doctor and a patient into formatted out-patient letters or natural language which goes into free-form text fields of EMR systems. This invention automates a process which is currently predominantly manual, namely the creation of out-patient letters and entries into EMR systems which consumes a lot of time of medical professionals such as physicians, medical assistants, scribes, etc.

In a preferred embodiment, the system consists of four modules or sets of modules:
1) a speech diarizer to separate voices of doctors and patients, as described, e.g. in Wooters, Chuck, and Marijn Huijbregts. “The ICSI RT07s speaker diarization system.” Multimodal Technologies for Perception of Humans (2008): 509-519;
2) a speech recognizer to transform speech of doctors and patients into unformatted text, see e.g. Povey, Daniel, et al. “The Kaldi speech recognition toolkit.” IEEE 2011 workshop on automatic speech recognition and understanding. No. EPFL-CONF-192584. IEEE Signal Processing Society, 2011;
3) a module to transform diarized spoken language in textual form into a conceptual graph representation;
4) a set of modules to create sub-sections of medical reports which can be concatenated to constitute the final report, or create narrative to fill specific free-form text fields of EMR systems.

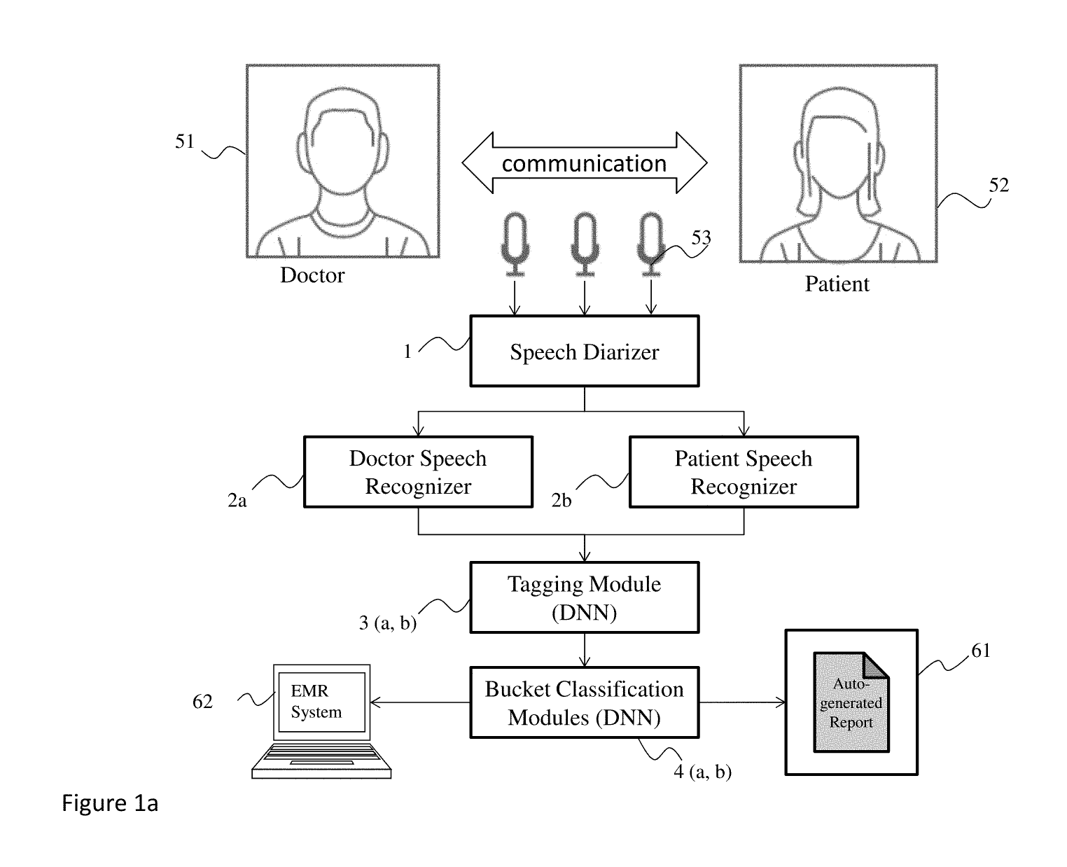

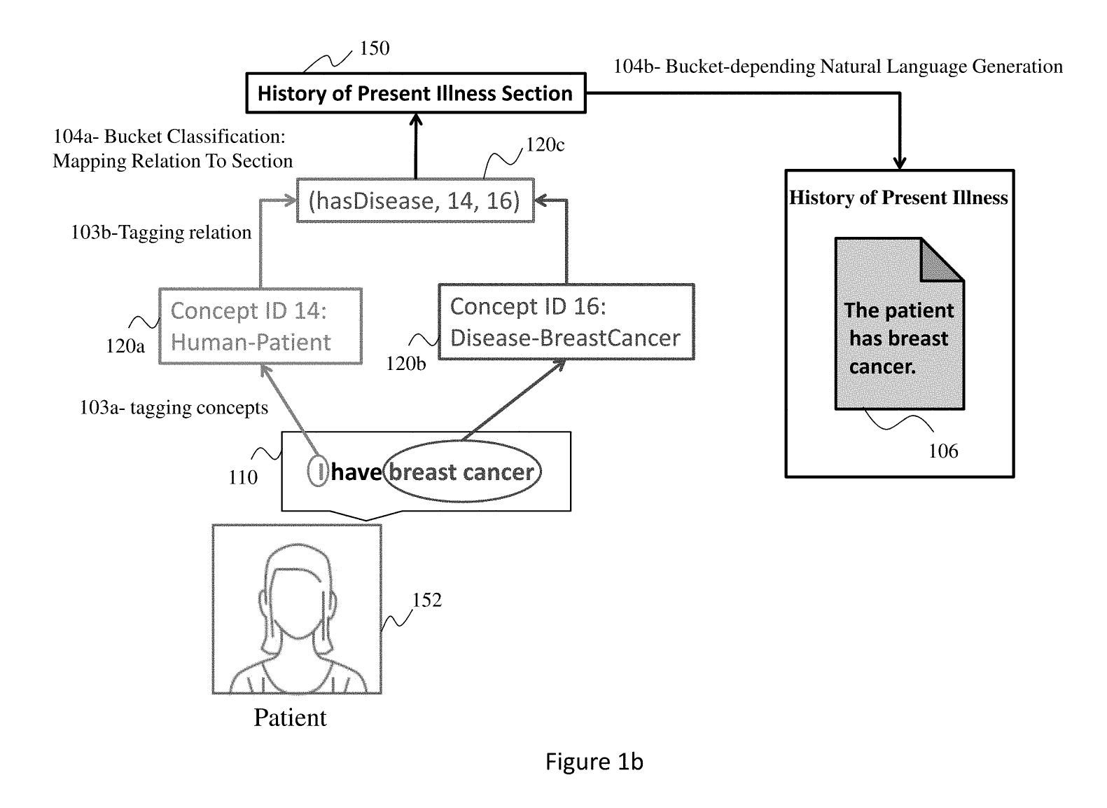

A visual representation of a preferred embodiment is shown in FIG. 1a. A doctor 51 and a patient 52 are having a communication. Their communication is picked up by the microphone array 53. A speech diarizer 1 separates the voices of doctor and patient. Speech recognizers 2a and 2b transform the speech of the doctor and patient into unformatted text, respectively. A tagging module 3 transforms diarized spoken language in textual form into a conceptual graph representation. Finally, a set of bucket classification modules 4 creates sub-sections of medical reports which can be concatenated to constitute the final report 61, or create narrative to fill specific free-form text fields of an EMR system 62.

While Modules 1 and 2 can be standard technologies, see the provided citations, Modules 3 and 4 are not standard, and will be described in further detail below. Tagging module 3 has two sub-modules, 3a and 3b. A bucket classification module 4 also has to sub-modules, 4b and 4b.

FIG. 1b shows how the modules 3 and 4 in FIG. 1a work. Tagging sub-module 3a tags concepts (103a). Tagging sub-module 3b tags relations (103b). Bucket classification sub-module 4a maps relation to a section (104a). Bucket classification sub-module 4b is capable of natural language generation (104b).

Module 3—a module to transform diarized spoken language in textual form into a conceptual graph representation. The output of Modules 1 and 2 combined are delivered to Module 3 as a sequence in the form word_1/speaker_1 word_2/speaker_2 . . . , for example

good/P morning/P doctor/P how/D are/D you/D . . . /P

where P means patient and D means doctor.

The task of turning this input into a conceptual graph representation is performed by two sub-modules, one for tagging concepts and one for tagging relations, described in the following:

Module 3a (FIG. 1a)—Tagging concepts from diarized speech (FIG. 1b, 103a). To automatically tag semantic concepts in diarized speech, we will make use of supervised machine learning, in particular a deep neural network (“DNN”) which needs to be trained on sample data. To create sample data, we need several thousand samples of transcriptions of typical doctor/patient interactions where semantic concepts had been semantically annotated in the following form:

well/D [Human-Patient I/P] have/P [Disease-BreastCancer breast/P cancer/P] ok/D

The set of possible semantic concepts can use predefined concepts, such as Human-Father, Human-Mother, Human-Patient, . . . , Location-Hospital, . . . , as derived from medical ontologies such as SNOMED CT or ICD-10, or they can be enhanced by concepts discovered by the annotators throughout the annotation process.

Using the annotated diarized speech input, we can now train a DNN-based tagger (e.g. a BLST with attention mechanism) which uses embeddings (e.g. with a window of 256 words times 128 embeddings). Here, the embeddings should be the concatenation of two vectors, a word vector and a speaker vector at the input. And the output should be one concept per input word, distinguishing words bearing no concept (0), ones which initiate a concept (e.g. Begin_Disease-BreastCancer), and those at the inside of a concept phrase (e.g. Continue_Disease-BreastCancer). This is an example tagging sequence:

well/D:0 I/P:Begin_Human-Patient have/P:0 breast/P:Begin_Disease-BreastCancer

cancer/P:Continue_Disease-BreastCancer ok/D:0

where “:” is the separator between in- and output.

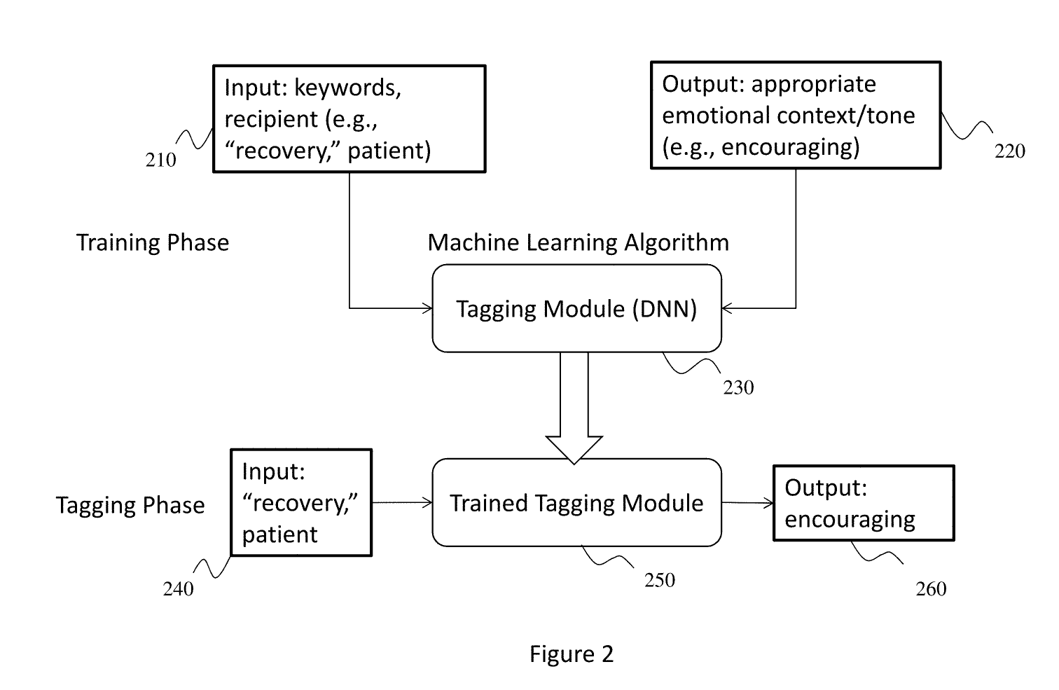

Module 3b (FIG. 1a)—Tagging relations between concepts in diarized speech (FIG. 2b, 103b). Similarly to Module 3a), a DNN is trained to perform this tagging task by using thousands of manually annotated samples of relations. Such annotated samples map language, speaker ID, and concept tags as produced at the end of Module 3a above, e.g.,

well/D:0 I/P:Begin_Human-Patient have/P:0 breast/P:Begin_Disease-BreastCancer

cancer/P:Continue_Disease-BreastCancer ok/D:0

to a limited set of relations, e.g.
hasDisease, causedBy, etc. Such relations are defined in, or informed by, standard medical ontologies such as SNOMED CT or ICD-10.

In order to be able to distinguish concepts of the same type and uniquely define relations, each instance of a concept in the input sequence to Module 3b is automatically assigned an ID (i.e. 16). The next encounter of the same concept would get another ID (e.g. 22). Hence, the input of the annotation internally has the form

well/D:0 I/P:Begin_14 have/P:0 breast/P:Begin_16 cancer/P:Continue_16 ok/D:0

where

ID 14 is Human-Patient (see FIG. 1b, 120a)

ID 16 is Disease-BreastCancer (see FIG. 1b, 120b)

ID 21 is Anomaly-Tumor

and the annotator annotates such an input sequence with relations between the individual concepts, e.g.,

(hasDisease, 14, 16) (see FIG. 1b, 120c)

which stands for

“the patient has breast cancer”

or

(causedBy, 16, 21)

which stands for

“the breast cancer is caused by a tumor”.

With these annotations, DNNs are trained for each relation type (hasDisease, causedBy, . . . ). The input layer of these DNNs consists of the concatenation of input and output layers of the DNN of Module 3a), and the output layer consists of a matrix over all possible parameter combinations the respective relation type can assume. E.g. for a relation with two parameters, such as hasDisease or causedBy, the number of nodes in the output layer is N̂2 with N being the maximum ID in the training data.

At run time, as during the training, the input of the DNN will be the concatenation of input and output layers of the DNN of Module 3a. To determine which relations were found, one needs to find all those output matrix nodes that fired, determining the tagged relations, e.g., there might be two nodes firing for the causedBy tagger, such as

(causedBy, 16, 21)

(causedBy, 34, 64)

Module 4 (FIG. 1a)—a set of modules to create sub-sections of medical reports which can be concatenated to constitute the final report, or create narrative to fill specific free-form text fields of EMR systems.

Module 4a (FIG. 1a)—bucket classification (FIG. 1b, 104a): First, we train a DNN which maps relations to sections, e.g. mapping (hasDisease, 14, 16) to the History of Present Illness section, which is a bucket on its own. This division between different sections is to help overcome data sparsity. As in Modules 3a and 3b, this is based on learning from human annotations where the input layer is a vector consisting of relation type and the relation's parameters, and output is the bucket ID.

Module 4b (FIG. 1a)—bucket-depending natural language generation (FIG. 1b, 104b): Do the following for every bucket:

select relations for the bucket

sort the relations alphabetically

use them as input of a DNN (this DNN should not be a recurrent neural network), e.g.

(causedBy, 16, 21)

(hasDisease, 14, 16)

( . . . )

0

0

where the zeros at the end are inserted to pad to the fixed width of the input layer (e.g. 256). The output of the bucket-dependent natural language generator has also a fixed number of nodes, e.g. 256, which consists of word indices in a vocabulary list, e.g.

34, 25, . . . , 48, 26, EOS, 87, 89, . . .

where EOS is the end-of-section marker. For example, this list of indices could stand for the natural language section

“the patient has breast cancer” (See FIG. 1b, 106)

In a preferred embodiment (FIG. 2), a DNN-based tagging module 230 can be trained to generate an appropriate emotional context or tone. First, a DNN 230 is trained using sample data. In especially preferred embodiments, sample data are contained in a dataset of pre-determined emotional subtext (e.g., Table 7. Subtext Table) and tone (e.g., Table 8. Tone Table). Sample data can also be manually annotated samples. During the training phase, the DNN 230 is trained with a machine learning algorithm to associate the appropriate emotional context, or tone, i.e., output 220, with an input 210, such as keywords and the identity of the recipient. During the tagging phase, the DNN 230 will be able to predict the appropriate emotional context or tone, i.e, generating an output 260, based on an input 240 that was identical or similar to an input 210 encountered during the training phase. For example, the DNN 230 can learn to associate an encouraging tone with the keyword “recovery” while the recipient is the patient. During the tagging phase, when the input is “recovery” and patient is the recipient, the trained tagging module will be able to predict that an encouraging tone should be used in generating a response.

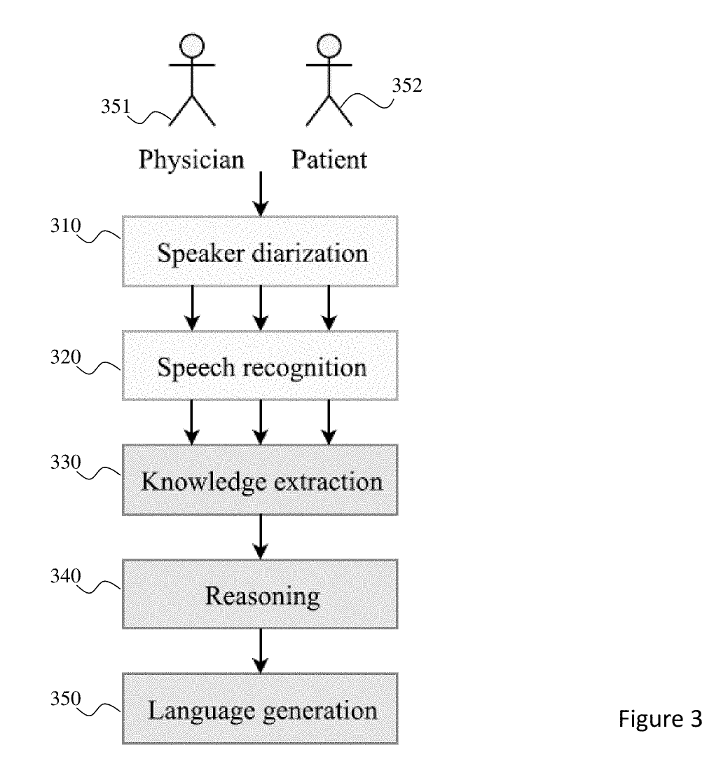

Another preferred embodiment (FIG. 3) features an automated scribe system for documenting clinical encounters (300). A (human) medical scribe is a clinical professional who charts patient-physician encounters in real time, relieving physicians of most of their administrative burden, substantially increasing productivity and job satisfaction. This embodiment presents a complete implementation of an automated medical scribe, providing a scalable, standardized, and economic alternative to human scribes. This embodiment involves speaker diarization (310), speech recognition (320), knowledge extraction (330), reasoning (340) and natural language generation (350).

The initial stages transform the recorded conversation into a text format usable by the natural language processing (NLP) modules that follow: first, a speaker diarization module determines who is speaking when and uses this information to break the audio recording into segments, which are then passed through a medical automatic speech recognition (ASR) stage. Following ASR, the scribe must convert a transcribed spontaneous conversation into a final and fully formatted report. The scribe does not perform this translation directly—this would require enormous amounts of parallel data to solve, end to end, with any single technique. Instead, a two-stage approach is developed in which the scribe mines the conversation for information and saves it in a structured format, then exports this structured data to the final report.

Between these two stages, there is a “reasoning” step that operates directly on the structured data to clean and prepare it for export, if needed. In this way, the bulk of the NLP work is divided into two well-studied problems: knowledge extraction (330) and natural language generation (350). Generating structured data as an intermediate step has other advantages as well; for one, it can be kept in the patient's history for use later by the scribe—or even by other systems, if it is saved in standardized structured data formats.

Speaker diarization (310) is the “who spoke when” problem, also called speaker indexing. The input is audio features sampled at 100 Hz frame rate, and the output is frame-labels indicating speaker identify for each frame. Four labels are possible: speaker 1 (e.g. the doctor), speaker 2 (e.g. the patient), overlap (both speakers), and silence (within-speaker pauses and between-speaker gaps). The great majority of doctor-patient encounters involve exactly two speakers. Although this method is easily generalizable to more speakers, the current embodiment focuses on the two-speaker problem.

The diarization broadly distinguishes “bottom-up” vs. “top-down” approaches. This embodiment uses a top-down approach that utilizes a modified expectation maximization (EM) algorithm at decoding time to learn the current speaker and background silence characteristics in real time. It is coded in plain C for maximum efficiency and currently operates at ˜50× real-time factor.

Diarization requires an expanded set of audio features compared to ASR. In ASR, only phoneme identity is of final interest, and so audio features are generally insensitive to speaker characteristics. By contrast, in diarization, only speaker identity is of final interest. Also, diarization performs a de facto speech activity detection (SAD), since states 1-3 vs. state 4 are speech vs. silence. Therefore features successful for SAD are helpful to diarization as well. Accordingly, an expanded set of gammatone-based audio features are used for the total SAD+diarization+ASR problem.

Speech recognition (320). ASR operates on the audio segments produced by the diarization stage, where each segment contains one conversational turn (1 speaker+possibly a few frames of overlap). Currently, the diarization and ASR stages are strictly separated and the ASR decoding operates by the same neural network (NN) methodology for general medical ASR. (See E Edwards et al, Medical speech recognition: reaching parity with humans. In Proc SPECOM, volume LNCS 10458, pages 512-524. Springer, 2017). In brief, the acoustic model (AM) consists of a NN trained to predict context-sensitive phones from the audio features; and the language model (LM) is a 3- or 4-gram statistical LM prepared with methods of interpolation and pruning that were developed to address the massive medicalvocabulary challenge. Decoding operates in real time by use of weighted finite-state transducer (WFST) methodology coded in C++. Our current challenge is to adapt the AM and LM to medical conversations, which have somewhat different statistics compared to medical dictations.

Knowledge extraction (330). A novel strategy is adopted to simplify the knowledge extraction problem by tagging sentences and turns in the conversation based upon the information they are likely to contain. These classes overlap largely with sections in the final report—chief complaint, medical history, etc. Then, a variety of strategies are applied, depending on the type of information being extracted, on filtered sections of text.

A hierarchical recurrent neural networks (RNNs) is used to tag turns and sentences with their predicted class; each sentence is represented by a single vector encoded by a word-level RNN with an attention mechanism. Sentences are classified individually rather than the entire document. In most cases, a sentence vector is generated from an entire speech turn; for longer turns, however, detection of sentence boundaries is required. This is essentially a punctuation restoration task, which has been undertaken using RNNs with attention. (See W Salloum, et al, Deep learning for punctuation restoration in medical reports. In Proc Workshop BioNLP, pages 159-164. ACL, 2017).

To extract information from tagged sentences, one or more of several strategies can be applied. One strategy is to use complete or partial string match to identify terms from ontologies. This is effective for concepts which do not vary much in representation, such as medications. Another strategy is extractive rules using regular expressions, which are well suited to predictable elements such as medication dosages, or certain temporal expressions (e.g., dates and durations). Other unsupervised or knowledge-based strategies, such as Lesk-style approaches in which semantic overlap with dictionary definitions of terms is used to normalize semantically equivalent phrases, as has been done successfully for medical concepts. These approaches are suitable for concepts that can vary widely in expression, such as descriptions of symptoms. Fully supervised machine learning approaches can be employed for difficult or highly specialized tasks—e.g., identifying facts not easily tied to an ontology entry, such as symptoms generally worsening.

The knowledge extraction (KE) stage also relies on extractive summary techniques where necessary, in which entire sentences may be copied directly if they refer to information that is tagged as relevant but is difficult to represent in our structured type system—for example, a description of how a patient sustained a workplace injury. At a later stage, extracted text is processed to fit seamlessly into the final report (e.g., changing pronouns).

Reasoning from extracted knowledge. Following the information extraction stage is a reasoning module (340), which performs several functions to validate the structured knowledge and prepare it for natural language generation. Through a series of logical checks, the reasoning module corrects for any gaps or inconsistencies in the extracted knowledge. These may occur when there is critical information that is not explicitly mentioned during the encounter, or if there are errors in diarization, ASR, or KE.

This stage also has access to the templates used when generating the final note. In the event that certain templates can only be partially filled, the reasoning module will attempt to intuit the missing information from existing structured data in the patient's history, if available. Wherever possible, data is also encoded in structures compatible with the HL7 FHIR v3 standard to facilitate interoperability with other systems. For example, if the physician states an intent to prescribe a medication, the extracted information is used to fill a FHIR MedicationRequest resource.

The natural language generation (NLG) module (350) produces and formats the final report. Medical reports follow a loosely standardized format, with sections appearing in a generally predictable order and with well-defined content within each section. Our strategy is a data-driven templatic approach supported by a finite-state “grammar” of report structure.

The template bank consists of sentence templates annotated for the structured data types necessary to complete them. This bank is filled by clustering sentences from a large corpus of medical reports according to semantic and syntactic similarity. The results of this stage are manually curated to ensure that strange or imprecise sentences cannot be generated by the system, and to ensure parsimony in the resulting type system.

Using the same reports, grammar is induced using a probabilistic finite-state graph, where each node is a sentence and a single path through the graph represents one actual or possible report. Decoding optimizes the maximal use of structured data and the likelihood of the path chosen. The grammar helps to improve upon one common criticism of templatic NLG approaches, which is the lack of variation in sentences, in a way that does not require any “inflation” of the template bank with synonyms or paraphrases: during decoding, different semantically equivalent templates may be selected based on context and the set of available facts, thus replicating the flow of natural language in existing notes.

Format does vary between note type—for example, outpatient notes are quite different from hospital discharge summaries—and even between providers. Separate NLG models are built to handle each type of output.

Finally, all notes pass through a processor that handles reference and anaphora (e.g., replacing references to the patient with the appropriate gender pronoun), truecasing, formatting, etc. generate a full template bank from data.

Exemplary Embodiments of an Automated System for, Communicating Information

Other aspects of the inventive subject matter include methods of, and/or an automated systems for, communicating information based in part on an oral communication between a plurality of persons. In these aspects, it is contemplated that the plurality of persons can be in various relationships. For example, two or more persons can be in a medical provider-patient, attorney-client, or other professional-client relationship, which often requires confidential communications. Other contemplated relationships include non-professional relationships, such as parent-child, or salesperson-potential customer relationships.

Contemplated communications can occur using any medium. For example, such communications can be in-person (e.g., face-to-face), over the phone, or over the internet (e.g., via Skype®, etc), and can be conducted entirely through voice, entirely through written or other visual symbols, or through a combination of voice and visual symbols. Other modalities are also contemplated, e.g. video or motion capture. Contemplated communications can be completed in a single-session (e.g., without being intervened for more than an hour, more than a day, etc), or during multiple-sessions communications. The latter, for example, might occur over a multi-month period of hospitalization.

In some embodiments of the inventive subject matter, an automated system converts oral communications between at least first and second persons into a written script (e.g., digitally, etc). Conversion can be in real-time, near-real time (within a minute), or at some subsequent time using a recording of the communication. Conversion can use local and/or remote data storage units.

From the script of an oral communication, the automated system can infer context(s) of the oral communication. As used herein, the term “context” refers to any environment in which the communication takes place. Examples of context include time, place, identity of the speakers (e.g., gender, name, occupation, etc) and relationships between speakers. Further, context can include a speaker's emotion, level of understanding, competence, and intent of the speaker in the communication, etc. Context can be inferred from the content of the voice, or from non-voice aspects of communication. For example, inferences from voice can be made using types of questions, types of answers, use of vocabulary, volume or tone of the speakers' voice, and/or other sounds the speaker makes during the conversation (e.g., laughter, crying, etc). Inferences from non-voice communication include body language (e.g., shrugging, cursing, pushing to show refusal etc) and facial expression (e.g., angry face, sad face, happy face, etc).

Inferences from non-voice communication need not even come from the speaker's voice or body. For example, inferences from oral communication between a real estate agent and a potential buyer could be derived from location, age and appearance of other family members present during the conversation. In a doctor-patient example, context inferences could be derived from the nature of the facility (e.g., an emergency room versus an arthritis clinic).

It is contemplated that both computer-derived content and computer-derived context of a communication can be used to infer diagnostic information. Such information can include the name and status of the disease (or symptom), any physical/mental symptoms related to the disease, potential and/or popular treatment methods and period, any potential side effects of the treatment methods, code(s) of the disease, procedure, diagnoses (e.g., SNOMED, ICD-10, etc), and so on. In some embodiments, the automated system can generate a list of questions related to the oral communication and the inferred diagnostic information to complete the diagnostic information. In these embodiments, the automated system can send (e.g., in real-time, etc) the list of questions or one question in each time to the speaker (e.g., doctor, medical provider), to ensure the inferred diagnostic information is correct or any further information can be collected to further diagnose the symptoms of the patients.

A simple example can be used to help understand some of these concepts. In this example, a patient and a doctor are talking in a hospital. Based on the following exchange, the automated system infers that the patient is an out-patient, and that the conversation is taking place in the doctor's office.
Patient: Recently, I began to have sharp pains on my wrist, and it's getting worse as time goes by.
Doctor: Hello Joe. I hope you didn't have to wait long in the reception area. I understand that you are having a lot of pain in your wrist. Oh, I see it's red and swollen. Does it hurt if I press here?
Patient: Ouch!!!
Doctor: Have you recently injured your wrist or arm? Have you ever fallen on your wrist?
Patient: I don't think so.
Doctor: Have you been using your hands in any unusual exercise or other activity recently?
Patient: Well . . . I practice Aikido several times a week, and that often involves wrist holds. But no more than normal.
Doctor: And what happens if I move your hand this way, or that?
Patient: Movement doesn't actually seem to make a difference. It just hurts like crazy all the time.
Doctor: Have you tried hot packs or ice packs?
Patient: I used both hot packs and ice packs because I wasn't sure which would work better.
Doctor: Did you have less pain with ice packs?
Patient: Oh no. Even worse! I had much more pain after I used ice packs! But heat seems to help.

Based on the content and context of the conversation described above, the automated system could infer that the patient has gouty arthritis, and might suggest that diagnosis to the doctor. The automated system might also send one or more questions to the doctor to ensure the right diagnostic information, including “Which wrist, left or right?” or “Is the wrist red and swollen?”

Inferences contemplated herein can be made with inference engines, using known techniques of forward and backward chaining, applied using rules sets acting upon a knowledge base. Examples of suitable inference engines that can be used to execute aspects of the inventive subject matter are referenced elsewhere herein.

Continuing with the previous example, it is contemplated that after a patient's visit to the doctor's office, the doctors or other entity would send a written communication to one or more persons depending on the diagnosis, request, or needs of billing. An important issue here is that different recipients might well need different types of information (e.g., diagnosis result, treatment, financial considerations, etc), and they likely would respond differently to the same type of information. Thus, in order to effectively deliver suitable message to different recipients, individuals, it is important to characterize recipients according to (a) the information they should be given (surface text), (b) any information they should be given as subtext, and (c) appropriate tone.

As used herein, the term “surface text” refers a literal or general meaning (e.g., dictionary definition, etc) of the phrase. The term “subtext” refers to any hidden or implicit meaning of the phrase that would be understood by the listener based on the context of the written communication as a whole or based on the prior communications, etc. The appropriate tone is determined contemplating the listener's potential emotional status (e.g., sad, happy, disappointed, etc), expected response to the information (e.g., resistive, admitting, etc), cultural diversity, and so on.

In the prior art, suitable messages are often prepared using forms. For example, many medical providers have computer systems that complete insurance forms. Although there may be different subparts depending on the diagnosis, treatment provided, and so forth, and although there may be different forms for different insurance companies, the bottom line is that someone in the medical office basically just fills out a form using available information.

Also in the prior art, when it comes time to instruct the patient with respect to treatments, many medical offices provide printed forms for the various different treatments. In the example above, for example, the office might well hand the patient a printed sheet with instructions on how to take medications that block uric acid production. Drugs called xanthine oxidase inhibitors, including Allopurinol or Febuxostat reduce uric acid, and Naproxen helps with pain and inflammation.

If instructions are to be provided to a caregiver (parent of a child, child of an elder parent, spouse, friend, etc) using prior art systems and methods, a medical office would again generally use a form, which might very well be the same instructional form that would be given to an independent patient.

All of this might work very well for simple and routine conditions and treatments. However, there is a trend towards providing more personalized service to patients, caregivers and others. And the need for personalization can increase with conditions and treatments that are less simple or less routine. For example, an elder patient might come into a doctor's office with his/her adult child or other caretaker. If the patient is deemed to have terminal cancer, it might be helpful to provide the patient and caretaker with generic brochures regarding cancer treatment options, but also to provide follow up letters. Such letters might have many different purposes, including providing more personalized information about the location and stage of this patient's condition, a well as specific information designed to protect the doctor and office against malpractice claims.

One way of accomplishing the goal of creating suitable messages is for the doctor, nurse, or other medical professional to speak into the system, perhaps during a conversation with the patient or caregiver, information about the desired letters, using keywords to identify the recipient (a) surface text, (b) the subtext, and (c) the appropriate tone. For example, the doctor could say the following to Mrs. Jones, and to Nancy, her caregiver adult child.
“Mrs. Jones, I'm going to have our office send you a letter summarizing what we did today. We'll specify the type of cancer you have, the treatment options we discussed, and what can be expected with each of the different options. You should read this letter carefully because it will be full of information. Of course, you should keep a positive attitude because in many instances this type of cancer can be resolved with modern treatments.

In a contemplated embodiment of the inventive subject matter, the system could key on several words in the doctor's speech to assist in drafting the letter. For example, from the doctor's speech the system could infer that the surface text should include the type of cancer, the treatment options discussed, and what can be expected with each of the different options. The subtext is that the patient could very well make a full recovery, and the tone is upbeat.

The doctor might then speak separately to Nancy, out of earshot of Mrs. Jones.
Nancy, this is pretty serious. Yes, this type of cancer can be resolved with modern treatments, but success goes way down with older patients. At your mother's age and condition, I am loathe to try more than 2 courses of chemo. And of course the side effects are pretty severe. Without treatment she has 6 months at the outset.

For this speech the system could infer that the surface text should include the prognosis, and the subtext should be that Nancy and her mother should seriously consider refusing all treatment. The system could infer that the tone of the letter to Nancy should be sad, and possibly apologetic that medical science doesn't have much to offer.

In another aspect of the inventive subject matter, a contemplated system could infer what would be appropriate surface text, subtext and tone from someone other than the doctor or other medical professional. For example, if a patient appears to be confused by terms the medical professional is using, the surface text could be a very simplified, dumbed-down version of the diagnosis, treatment and prognosis, the subtext could be that the patient should avoid reliance on any self-diagnosis, and the tone could be paternal. As another example, it may be that the patient is experiencing considerable denial regarding his condition, and consequently has a serious argument in the doctor's office with a caregiver spouse or friend. From that argument the system could infer that a summary to the patient should provide only superficial information, with subtext that the patient needs to listen to direction provided by the caregiver, and that the tone should be non-confrontational.

Rather than inferring the text, subtext and tone from the doctor's speech, those things could be derived from a database that relies somewhat or even entirely on correlations among relevant factors previously entered into a medical records system, including: diagnosis, treatment, prognosis, patient age, general physical condition, habits (smoking, exercise, etc), whether the recipient is the patient, adult or child caregiver, insurance company, employer, etc.

It is greatly preferred that the contemplated systems would not use “stock phrases” to generate written output. Rather, modern, machine-learning based techniques such as phrase-based or DNN-based machine translation techniques would be employed.

On the other hand, if stock phrases are used, they should be selected to conform to a desired impact respect to surface text, subtext and tone, and that impact derived through inference or otherwise, the automated system can access to a database of a plurality of stock phrases. The stock phrases can include any sentences (complete, incomplete, or partial sentences, etc), phrases, or group of words that can be used to generate a written communication. In some embodiments, at least some of the stock phrases can be tagged with one or more key words that represent the appropriate tone, the surface text, or the subtext such that stock phrase can be sorted/grouped/pulled based on the tagged languages. The types of keywords can vary, including the name of the disease, listener's age or status, level of comfort (high to low), level of explicitness (explicit to implicit), etc. In these embodiments, it is also preferred that the stock phrases are pre-paired with one or more keywords indicating the diagnostic information, conditions of the patients, environment of the patients (e.g., family environment, social status, etc).

Based on the desired impact, inferred diagnostic information, the automated system can select one or more stock phrases, place them in an appropriate order, and generate a written communication to an individual listener. For example, for delivering messages to a patient who is 50 years old and got diagnosed with the third stage of lung cancer, the written communication can comprise a group of stock phrases with encouraging tones so that the patient understands that he might have a serious disease but could overcome by diligently receiving treatments. For other example, for delivering messages to a patient's family, where the patient is 90 years old and got diagnosed with the terminal stage of brain cancer, the written communication can comprise a group of stock phrases that accurately delivers the diagnostic information, expected progress of the cancer in next several months, and what the family members can do for the patient during those period of time.

In some embodiments, the automated system can determine when the written communication should be delivered and designate the future time points for delivery. For example, the automated system can generate multiple written communications by estimating progress/situations of the status or treatment progress of the patient, and send one or more written communications at a different time point than others (e.g., one each per month, one each after each treatment period (e.g., each stage of chemotherapy, etc)). In these embodiments, it is also contemplated that the written communications that are supposed to be sent in a later time point can be automatically updated based on the changed status of patients, progress of the treatment, or response to the earlier written communications (e.g., to the family members, to the patients, etc).

It should be apparent to those skilled in the art that many more modifications besides those already described are possible without departing from the disclosed concepts herein. The disclosed subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

In some embodiments, keywords extracted from a doctor-patient conversation can be correlated with more potential diagnoses, using the Conversation Keyword Table (Table 1). For example, keywords for communication between doctor and patient suffering from breast cancer can conclude that a patient might have BC3. Some embodiments may have different tables for each different diagnosis, or a single table with an extra column to designate diagnosis. Moreover, different signs and symptoms can be weighted differently, and negative answers can be weighed differently from positive answers.

TABLE 1
Conversation Keyword Table

| | Key words | | | | | |
|---|---|---|---|---|---|---|
| | | | | | | No |
| | breast | swelling | lump | pain | foot | bleeding |
| Potential | BC1 | | | | | BC1 |
| diagnosis | | | | | | |
| Potential | BC2 | | BC2 | | | BC2 |
| diagnosis | | | | | | |
| Potential | BC3 | BC3 | BC3 | | Diabetes3 | BC3 |
| diagnosis | | | | | | |
| Potential | BC4 | BC4 | BC4 | BC4 | Diabetes4 | |
| diagnosis | | | | | | |
| Potential | BC5 | BC5 | BC5 | BC5 | | |
| diagnosis | | | | | | |

In some embodiments, potential diagnoses could then be correlated with potential treatments using the Potential Treatments Table (Table 2). Potential treatments could then be correlated with potential prognoses using the Potential Prognoses Table (Table 3). For example, based on the consultation, the system could infer that the patient might have BC3 type or stage of cancer, and needs further tests to confirm. For a BC3 patient, treatment options TX2, TX3 are currently available and recommended. Based on the result of treatment options TX2, TX3, the prognosis of the patient is Prgo3 and Prgo4.

TABLE 2
Potential Treatments Table

| diagnosis | BC1 | BC2 | BC3 | BC4 | BC5 |
|---|---|---|---|---|---|
| Treatment | Tx1 | Tx1 | | | |
| method | | | | | |
| Treatment | | Tx2 | TX2 | | |
| method | | | | | |
| Treatment | | | TX3 | TX3 | |
| method | | | | | |
| Treatment | | | | TX4 | TX4 |
| method | | | | | |
| Treatment | | | | | TX5 |
| method | | | | | |

TABLE 3
Potential Prognosis

| | BC1 | BC2 | BC3 | BC4 | BC5 |
|---|---|---|---|---|---|
| Prognosis | Prgo1 | | | | |
| Prognosis | Prgo2 | Prgo2 | | | |
| Prognosis | | Prgo3 | Prgo3 | | |
| Prognosis | | | Prgo4 | Prgo4 | |
| Prognosis | | | | Prgo5 | Prgo5 |

In some embodiments, the surface text of the summary could include potential diagnoses, potential treatments, and potential prognoses. The specific phrases chosen could be taken from the Diagnosis to Phrase (Table 4), the Treatment to Phrase (Table 5), and the Prognosis to Phrase (Table 6) tables. Different phrase tables may have different columns that provide phrasing specific to different types of recipients, according to the recipient relationship to the patient. To the extent that the doctor (or other medical professional) expressly stated a diagnosis, treatment or prognoses, then the system could jump directly to the phrase tables.

TABLE 4
Diagnosis to Phrase

| | | | | | | Phrase to |
|---|---|---|---|---|---|---|
| | | | | | | other medical |
| Diagnosis | Phrase to patient | Phrase to parent | Phrase to adult child | Phrase to sibling | Phrase to insurance | professionals |
| BR1 | Informative phrase | Informative phrase | Informative phrase | Informative phrase | Informative phrase | Informative phrase |
| | (e.g., very early | (e.g., very early | (e.g., very early | (e.g., very early | (e.g., phase I) | (e.g., phase I) |
| | stage) | stage) | stage) | stage) | | |
| BR2 | Informative phrase | Informative phrase | Informative phrase | Informative phrase | Informative phrase | Informative phrase |
| BR3 | Informative phrase | Informative phrase | Informative phrase | Informative phrase | Informative phrase | Informative phrase |
| BR4 | Redacted phrase | Informative phrase | Informative phrase | Informative phrase | Informative phrase | Informative phrase |
| BR5 | Redacted phrase | Informative phrase | Informative phrase | Informative phrase | Informative phrase | Informative phrase |
| | (e.g., advanced | (e.g., terminal) | (e.g., terminal) | (e.g., terminal) | (e.g., terminal) | (e.g., terminal) |
| | rather than terminal) | | | | | |

TABLE 5
Treatment to Phrase

| | | | | | | Phrase to |
|---|---|---|---|---|---|---|
| | | | | | | other medical |
| Treatment | Phrase to patient | Phrase to parent | Phrase to adult child | Phrase to sibling | Phrase to insurance | professionals |
| BR1 | Informative phrase | Informative phrase | Informative phrase | Informative phrase | Informative phrase | Informative phrase |
| | (e.g., can be treated | (success rate is | (success rate is | (success rate is | (TX1 and TX23 is | (TX1 and TX2 is |
| | without hardship) | high) | high) | high) | recommended, and the | recommended, and |
| | | | | | cost and length of | side effect of xxx is |
| | | | | | treatment is . . .) | expected. Need to watch |
| | | | | | | for xxx side effect |
| | | | | | | symptoms) |
| BR2 | Informative phrase | Informative phrase | Informative phrase | Informative phrase | Informative phrase | Informative phrase |
| | (e.g., can be treated | (success rate is | (success rate is | (success rate is | (TX2 and TX3 are | (TX2 and TX3 are |
| | without hardship) | high) | high) | high) | recommended, and the | recommended, and |
| | | | | | cost and length of | side effect of xxx is |
| | | | | | treatment is . . .) | expected. Need to watch |
| | | | | | | for xxx side effect |
| | | | | | | symptoms) |
| BR3 | Informative phrase | Informative phrase | Informative phrase | Informative phrase | Informative phrase | Informative phrase |
| | (treatable with | (treatable with | (treatable with | (treatable with | (TX3 and TX4 are | (TX2 and TX3 are |
| | several options, | several options, | several options, | several options, | recommended, and | recommended, and |
| | but success rate | and realistic | and realistic | and realistic | the cost and length of | side effect of xxx is |
| | is high) | success rate) | success rate) | success rate) | treatment is . . .) | expected. Need to watch |
| | | | | | | for xxx side effect |
| | | | | | | symptoms) |
| BR4 | Informative phrase | Informative phrase | Informative phrase | Informative phrase | Informative phrase | Informative phrase |
| | (treatable with | (treatable with | (treatable with | (treatable with | (TX4 and TX5 are | (TX4 and TX5 are |
| | several options, | several options, | several options, | several options, | recommended, and | recommended, and |
| | but success rate | and realistic | and realistic | and realistic | the cost and length of | side effect of xxx is |
| | is moderate) | success rate) | success rate) | success rate) | treatment is . . .) | expected. Need to watch |
| | | | | | | for xxx side effect |
| | | | | | | symptoms) |
| BR5 | Informative phrase | Informative phrase | Informative phrase | Informative phrase | Informative phrase | Informative phrase |
| | (treatable with | (treatable with | (treatable with | (treatable with | (TX5 is recommended, | (TX5 is recommended |
| | option X, and still | option X, realistic | option X, realistic | option X, realistic | and the cost and | and side effect of xxx |
| | possible to overcome | success rate) | success rate) | success rate) | length of treatment | is expected. Need to |
| | the disease) | | | | is . . .) | watch for xxx side |
| | | | | | | effect symptoms) |

FIG. 6. Prognosis to Phrase

| | | | | | | Phrase to |
|---|---|---|---|---|---|---|
| | | | | | | other medical |
| Prognosis | Phrase to patient | Phrase to parent | Phrase to child | Phrase to sibling | Phrase to insurance | professionals |
| Prgo 1 | Very optimistic to | Very optimistic to | Very optimistic to | Very optimistic to | realistic success rate | realistic success rate |
| | recover after | recover after | recover after | recover after | of treatment and | of treatment and |
| | treatment | treatment | treatment | treatment | possibility of | possible complications |
| | | | | | recurrence | after treatment. |
| Prgo 2 | Very optimistic to | Very optimistic to | Very optimistic to | Very optimistic to | realistic success rate | realistic success rate |
| | recover after | recover after | recover after | recover after | of treatment and | of treatment and |
| | treatment | treatment | treatment | treatment | possibility of | possible complications |
| | | | | | recurrence | after treatment. |
| Prgo 3 | optimistic to | optimistic to | optimistic to | optimistic to | realistic success rate | realistic success rate |
| | recover after | recover after | recover after | recover after | of treatment and | of treatment and |
| | treatment | treatment | treatment | treatment | possibility of | possible complications |
| | | | | | recurrence | after treatment. |
| Prgo 4 | Possibility to | Possibility to | Possibility to | Possibility to | realistic success rate | realistic success rate |
| | recover after | recover after | recover after | recover after | of treatment and | of treatment and |
| | treatment, Survival | treatment, Survival | treatment, Survival | treatment, Survival | possibility of | possible complications |
| | rate and possible | rate and possible | rate and possible | rate and possible | recurrence | after treatment. |
| | complications | complications | complications | complications | | |
| Prgo 5 | Possibility to | Survival rate and | Survival rate and | Survival rate and | realistic success rate | realistic success rate |
| | recover after | expected life | expected life | expected life | of treatment and | of treatment and |
| | treatment, Survival | length | length | length | possibility of | possible complications |
| | rate and possible | | | | recurrence. Survival | after treatment. |
| | complications | | | | rate and expected | Survival rate and |
| | | | | | life length | expected life length |

In some embodiments, from the other keywords spoken in the conversation, as well as biographical information, diagnostic and treatment options, the system can use the Subtext Table (Table 7) to determine Appropriate Emotional Context (Tone). From the Appropriate Emotional Context (Tone), the system could use the Tone Table (Table 8) to find phrases that could be included in a summary, according to the type of recipient. A summary can be generated using appropriate surface text, subtext and tone. In other embodiments, there are surface text phrases, tone phrases, but no specific subtext phrases, since subtext phrases are already incorporated into the tone phrases.

TABLE 7
Subtext Table

| | Recipient's | Diagnosis and | Appropriate |
|---|---|---|---|
| | Biographic | Treatment | Emotional |
| keywords | Information | Options | Context (Tone) |
| recovery | elderly | BC3, and | compassionate |
| | spouse | treatable with | |
| | and/or adult | chemo and | |
| | children of | surgery. | |
| | the patient | | |
| recovery | Patient | BC3, and | encouraging |
| | herself | treatable with | |
| | | chemo and | |
| | | surgery. | |
| success rate | elderly | BC3, and | informative |
| | spouse | treatable with | |
| | and/or adult | chemo and | |
| | children of | surgery. | |
| | the patient | | |
| unlikely | elderly | BC3 but with | disheartening |
| | spouse | metastasis, and | |
| | and/or adult | partially | |
| | children of | treatable with | |
| | the patient | chemo and | |
| | | surgery. | |
| statistics | Insurance | BC3, survival | informative |
| | company | rate after | |
| | | treatment is 40% | |
| | | . . . | |
| statistics | elderly | BC3, survival | compassionate |
| | spouse | rate after | |
| | and/or adult | treatment is 40% | |
| | children of | . . . | |
| | the patient | | |
| statistics | Patient | BC3, survival | encouraging |
| | herself | rate after | |
| | | treatment is 40% | |
| | | . . . | |
| challenging | elderly | BC3 but with | compassionate |
| | spouse | metastasis, and | |
| | and/or adult | partially | |
| | children of | treatable with | |
| | the patient | chemo and | |
| | | surgery. | |
| too late | elderly | BC3 but with | disheartening |
| | spouse | metastasis, and | |
| | and/or adult | partially | |
| | children of | treatable with | |
| | the patient | chemo and | |
| | | surgery. | |
| affairs in order | elderly | BC3 but with | disheartening |
| | spouse | metastasis, and | |
| | and/or adult | partially | |
| | children of | treatable with | |
| | the patient | chemo and | |
| | | surgery. | |
| talk with your | elderly | BC3 but with | disheartening |
| minister | spouse | metastasis, and | |
| | and/or adult | partially | |
| | children of | treatable with | |
| | the patient | chemo and | |
| | | surgery. | |
| religion | elderly | BC3 but with | disheartening |
| | spouse | metastasis, and | |
| | and/or adult | partially | |
| | children of | treatable with | |
| | the patient | chemo and | |
| | | surgery. | |

TABLE 8
Tone Table

| | Phrase to | Phrase to | Phrase to | Phrase to | Phrase to |
|---|---|---|---|---|---|
| keywords | patient | parent | child | sibling | insurance |
| compassionate | I understand | | | | n/a |
| | that it is hard | | | | |
| | to admit that | | | | |
| | you have | | | | |
| | cancer . . . | | | | |
| | However, | | | | |
| encouraging | Many patients | BC3, survival | BC3, survival | BC3, survival | n/a |
| | like you, | rate after | rate after | rate after | |
| | larger | treatment is | treatment is | treatment is | |
| | percentage | 40%, but it is | 40%, but it is | 40%, but it is | |
| | than other | still hopeful | still hopeful | still hopeful | |
| | types of | as the | as the | as the | |
| | cancer, | prognosis is | prognosis is | prognosis is | |
| | completely | better than | better than | better than | |
| | recovers . . . | other types of | other types of | other types of | |
| | | cancers | cancers | cancers | |
| informative | | | | | In this stage |
| | | | | | of BC3, |
| | | | | | treatment |
| | | | | | options |
| | | | | | includes . . . |
| | | | | | and the |
| | | | | | expected |
| | | | | | cost and |
| | | | | | length is |
| | | | | | xxx. |
| disheartening | I wish I could | It is | It is | It is | n/a |
| | deliver better | heartbreaking | heartbreaking | heartbreaking | |
| | news to you | to inform you | to inform you | to inform you | |
| | regarding | that . . . | that . . . | that . . . | |
| | your | | | | |
| | conditions, | | | | |
| | however, . . . | | | | |

What is claimed is:

1. An automated system for deriving at least one of surface text, subtext, and tone from a communication comprising words and phrases, the system comprising a tagging module that (i) annotates at least some of the words or phrases with a semantic concept, and (ii) associates one or more relations between at least some of semantic concepts.

2. The system in claim 1, wherein the automated system infers at least one of a surface text, a subtext, and a tone from at least one of the words, prosody, or cues of the communication.

3. The system of claim 1, wherein the automated system infers at least one of a surface text, a subtext, and a tone from at least one biographical information, diagnoses, prognosis, or treatment options.

4. The system in claim 1, wherein the automated system uses an artificial intelligence system to determine at least one of a surface text, a subtext, and a tone.

5. The system in claim 1, wherein the automated system accesses a database of a plurality of stock phrases to determine at least one of a surface text, a subtext, and a tone.

6. An automated system for transforming recordings or diarized texts of interactions between a first person and a second person into a narrative, comprising:
a non-transitory storage medium;
a set of executable software instructions stored in the non-transitory storage medium and comprising:
(i) a tagging module having a first sub-module programmed to tag words or phrases from the interactions with semantic concepts, and a second sub-module programmed to associate one or more relations between at least some of semantic concepts; and
(ii) a bucket classification module programmed to map the relations to one or more sub-sections of the narrative.

7. The system of claim 6, wherein the first person is a medical professional and the second person a patient.

8. The system of claim 7, wherein at least some of the concepts are based on medical ontologies.

9. The system of claim 6, wherein the tagging module comprises a deep neural network (DNN) trained on sample data created with transcriptions of interactions between a doctor and a patient where semantic concepts had been manually annotated.

10. The system of claim 9, wherein the first sub-module further comprises:
an input layer comprising a word vector or a speaker vector; and
an output layer comprising a concept.

11. The system of claim 10, wherein the second sub-module further comprises:
an input layer comprising a word vector, a speaker vector, or a concept; and
an output layer comprising a matrix over all possible combinations of concepts for each relation.

12. The system of claim 6, wherein the bucket classification module comprises a deep neural network (DNN).

13. The system of claim 6, wherein the bucket classification module further comprises:
an input layer comprising a relation vector or a parameter vector; and
an output comprising an ID of a section.

14. The system of claim 6, wherein the bucket classification module is further programmed to generate natural language by selecting relations within a bucket, sorting them alphabetically, and using them as an input of a DNN.

15. A method of generating a response based at least in part on a communication, comprising:
annotating words or phrases in the communication with semantic concepts;
associating one or more relations between at least some of the semantic concepts; and
deriving at least one of a surface text, subtext, and tone for the response.

16. The system of claim 15, wherein the response comprises potential diagnoses, potential treatments, or potential prognoses.

17. The method of claim 15, wherein the step of deriving at least one of a surface text, subtext, and tone for the response comprises selecting and assembling stock phrases.

18. The method of claim 15, wherein the communication is between a doctor and a patient.

19. The method of claim 18, wherein the step of deriving at least one of a surface text, subtext, and tone for the response comprises inferring from diagnostic information, doctor and recipient's respective contexts, and desired impacts on the recipient of the response.
